(19) United States
(12) Patent Application Publication
(10) Pub. No.: US 2010/0148459 A1
(43) Pub. Date: Jun. 17, 2010

(54) Hand held skating device

(76) Inventor: Allen G. Johnston, Lubbock, TX (US)

Correspondence Address: Allen G. Johnston, 3726 B 53RD ST, LUBBOCK, TX, 79072, US

(21) Appl. No.: 12/586,755

(22) Filed: Sep. 28, 2009

Related U.S. Application Data
(60) Provisional application No. 61/100,723, filed on Sep. 27, 2008.

(51) Int. Cl. B62M 1/00; A63C 1/00; B60T 1/14; B62B 17/02; A63C 1/30

(52) U.S. Cl. 280/87.01; 280/841; 188/5; 280/28.5; 280/11.18

(57) ABSTRACT

A new skating device having a handle which is held by a skater. Wheels, ice blades, or other means of conveyance are placed in front, behind and on both sides of the handle or extend to the front, behind and on both sides of the handle, thus holding the device upright as it conveys the skater across a skating surface. Two or more of the wheels or ice blades are directionally fixed, allowing only forwards or backwards movement. The device allows a skater to skate with hands down against a skating surface. Other skate devices such as inline skates can support the skater's lower body allowing the skater to skate in a prone or crab position. Optional brakes, fenders, hand guards, grind plates and padding for the handle can be added to facilitate the activity which the device will be used for.

### CROSS-REFERENCE TO RELATED APPLICATIONS

Pursuant to 35 U.S.C. §119©, this application claims the benefit of U.S. Provisional Patent Application No. 61/100,723, entitled Hand Held Skating Device, filed Sep. 27, 2008, and named Allen G. Johnston as inventor, which is hereby incorporated by reference for all purposes.

### TECHNICAL FIELD OF THE INVENTION

This invention generally relates to skating equipment, specifically to skating equipment used to move a human body across a hard surface.

### BACKGROUND OF THE INVENTION

### Prior Art

Previously wheeled and ice skating devices have been designed to support the weight of the human body by holding the feet off a surface. These devices were built onto the user's foot apparel or strapped on the same. In the event of loss of balance or a fall, the person's hands or body would contact the hard surface. This problem has only been partially solved by the use of wrist guards and padding. Hand held wheeled devices have been made for exercise purposes, but these devices, Swivel Caster Supported Exercising Handle Apparatus U.S. Pat. No. 3,809,393 issued to Jones on May 7, 1974 and Full Body Exerciser U.S. Pat. No. 6,602,170 B2 issued to Ilic on Aug. 5, 2003, are made to be used in a stationary manner and are not designed for high speed skating maneuvers.

The device entitled Body Sled U.S. Pat. No. 4,413,832 issued to Pendleton on Nov. 8, 1983 has forearm runners which are used to contact the snow and guide the wearer. Two patents, Accessory for in-line Skates U.S. Pat. No. 5,979,939 issued to Siboni on Nov. 9, 1999 and Armor with Rollers U.S. Pat. No. 5,926,857 issued to Blondeau on Jul. 27, 1999, describe hand held palm and forearm devices to be used in extreme skating and acrobatic moves. These devices are strapped to the hand or forearm of the user. The elbow and forearm are then used to absorb large forces of impact which can lead to painful injury to the user. Because the devices are strapped to the user, they cannot be quickly removed to change activities. The use of one or more in-line wheels on the second two devices requires the user to apply constant force to maintain balance.

The present invention represents an entirely new way of skating which allows the skater to use in-line, other type skates and a number of other rolling apparatus in conjunction with the device, and can be used singly or in pairs. It also is designed to allow the user to remove the wheels on the hand held skate and bolt on ice skate blades to be used in ice skating activities, similar to Adapter for Converting In-line Roller Skates to Ice Skates U.S. Pat. No. 6,481,724 B1 issued to Whipp on Nov. 19, 2002. It permits a broader range of new extreme skating moves with greater variety of acrobatic movements at greater speed and with greatly improved maneuverability. This invention allows the user, using wheels or ice skate blades attached to the invention, to skate in a prone or push-up position or in the crab position while wearing any number of other skating shoes or devices and to perform hand stand type maneuvers.

The advantages of this invention are as follows:
a.) holding the device with hands allows the arms and shoulders to distribute the impact,
b.) not requiring a means for attaching the device to the hand frees the user to participate in other sports and/or activities without the inconvenience of removing straps or other means of attachment to set the device aside,
c.) design of invention and specific placement of support systems such as wheels and ice skate blades ensures minimal force is required to maintain balance and control direction,
d.) device design allows the user to propel themselves with the hand held device while the lower body is supported by a wheeled or ice skating device, and
e.) optional grind plates and brakes that allow user to perform a large variety of extreme skating maneuvers with the hand held device.

### SUMMARY OF THE INVENTION

This present invention provides a hand held device which consists of one or more unidirectional surface contacting conveyance components such as ice blades or wheels mounted on a frame which forms a substantially straight hand grip. One embodiment has wheels which are aligned with the hand grip in a fixed position such that the front wheels are forward of the hand grip and the rear wheels are rearward of the handgrip. The said hand grip is generally but not necessarily aligned with the direction of travel.

Other technical advantages will become apparent from the following figures, description, and claims.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which FIGS. 1-10 show the preferred embodiment. In particular:

FIG. 1 is a perspective view of the preferred embodiment.

FIGS. 2A-2C are views of the frame assembly.

FIGS. 3A-3C are views of the brake arm assembly.

FIGS. 4A-4C are views of the brake lever assembly.

FIGS. 5A-5B show views of the frame with complete brake assembly and wheels installed.

FIG. 6A shows a skater in the prone position, wearing in-line skates and using a hand skate in each hand.

FIG. 6B shows a skater in the prone position with a wheeled cart supporting the lower body and holding a hand skate in each hand.

FIGS. 7A-D are drawings showing examples of movements as well as possible skating devices that may be used with the hand held skates.

FIGS. 8A-8F show the ice accessories for the preferred embodiment.

FIGS. 9A-9C are views of the frame assembly with the ice accessories attached.

FIG. 10 shows a skater in the prone position with ice runner cart supporting the lower body and holding an ice hand skate in each hand.

FIGS. 11A-11F are cross-sections of various tubular frames.

FIGS. 12A-12E are cross-sections and side views of various hand guards.

FIGS. 13A-13C are side views of various fenders.

FIGS. 14A-14F are side views and cross-sections of various grindplates.

FIGS. 15A-15G are cross-sections of various wheels.

FIGS. 16A-16H are side views of various brake systems.

FIGS. 17A-17B are side views of a finger operated brake lever and a thumb operated brake lever.

FIGS. 18A-18J are various wheel arrangements around the handle.

FIGS. 19A-19C shows an alternate embodiment that allows a zero turning radius.

FIGS. 20A-20G shows an alternate embodiment which has a folding frame.

FIGS. 21A-21E shows an ice only embodiment and its included parts.

FIGS. 22A-22B show alternate embodiments which include side wheels.

### DETAILED DESCRIPTION OF THE INVENTION

It should be understood at the outset that although an exemplary implementation of the present invention is illustrated below, the present invention may be implemented using any number of techniques, materials, designs and configurations whether currently known or in existence. The present invention should in no way be limited to the exemplary implementation, drawings, and techniques illustrated below, including the exemplary designs and implementations illustrated and described herein. Thus, the present invention should in no way be construed to be limited to the exemplary implementations, drawings, and techniques illustrated and described herein.

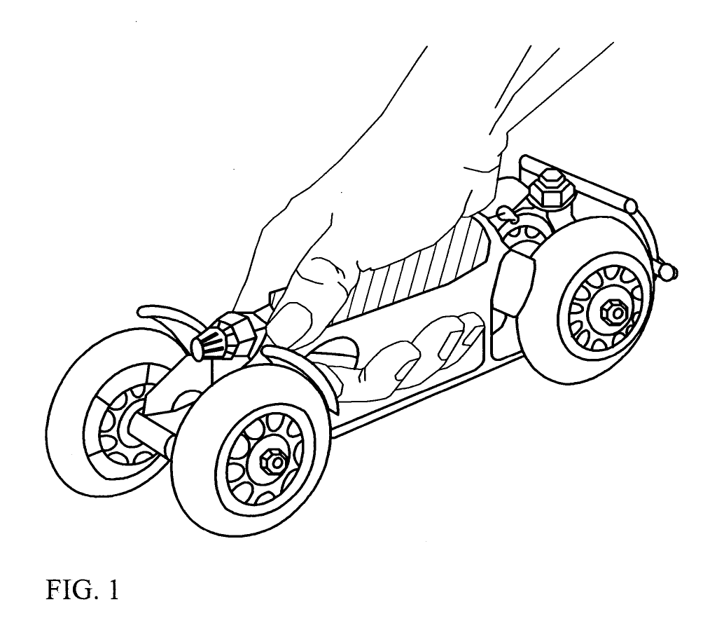

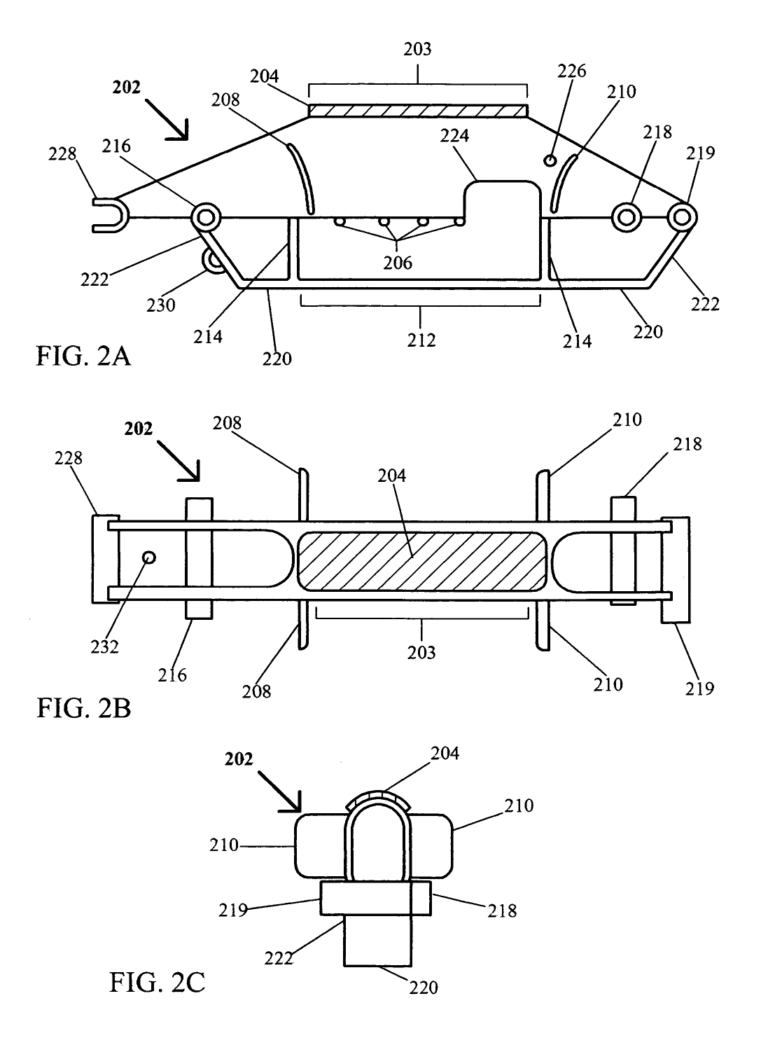

FIG. 1 is a perspective view of the hand held skate 100 which is the preferred embodiment of the present invention. A hand is shown holding the hand skate 100 which is also the object of FIGS. 2A-10.

FIG. 2A is a side view of the frame assembly 202 of the hand skate 100. The frame assembly 202 is a rigid tube that is parallel to both the ground and direction of travel. A handle section 203 is in the center of the frame assembly 202. The handle 203 is long enough to be held by an adult hand. Padding 204 is attached to the top of the handle 203. Finger gripping ridges 206 are attached to the bottom of the handle 203.

Rear fenders 208 extend to both sides behind the handle 203 to keep the hand from moving backwards. Front fenders 210 extend to both sides in front of the handle 203 to keep the hand from moving forward. A hand guard 212 is attached below the handle 203 with vertical braces 214 to keep the fingers from touching the ground.

Behind the rear fenders 208 a rear axle mounting tube 216 is attached to the bottom of the frame assembly 202. The rear axle tube 216 is parallel to the ground and perpendicular to the direction of travel. In front of the front fenders 210, the front axle mounting tube 218 is attached to the bottom of the frame assembly 202. In front of the front axle tube 218, a second axle tube 219 is attached to the front of frame assembly 202. Both front axle tubes 218 & 219 are parallel to the ground and perpendicular to the direction of travel.

A grindplate 220 is attached to the bottom of the hand guard 212. The grindplate 220 extends from the front axle tube 219 rearward to the rear axle tube 216 and is attached front and back with vertical braces 222.

At the front bottom of the handle 203, a cut-out 224 extends upward in the frame assembly 202 for the brake lever assembly 402 (not shown). Just in front and above the cut-out 224, and perpendicular to the frame 202, a pivot point hole 226 extends through the frame 202. Behind the rear axle tube 216 a u-shaped channel 228 is attached to the rear of the frame 202, perpendicular to said frame 202. The open part of the channel 228 points rearward and provides a pivot point for the brake arm assembly 302 (not shown). A brake spring mounting loop 230 is attached to the rear of the back vertical grindplate brace 222. The top back of the frame 202 is cut off from the back of the handle padding 204 to the brake pivot point 228. The top front of the frame 202 is cut off from the front of the handle padding 204 to the front axle tube 219.

FIG. 2B is a top view of the frame 202 with the front to the right. The rear axle tube 216 extends outward past both sides of the frame 202. The front axle tube 218 is even on the first side and extends outward from the second side of the frame 202. The front axle tube 219 is even on the second side and extends outward from the first side of the frame 202. A hole 232 is placed in the bottom of the frame 202 between the rear axle tube 216 and the brake pivot point 228.

FIG. 2C is a front view of the frame 202. The tube that forms the frame 202 is oblong in shape with vertical orientation.

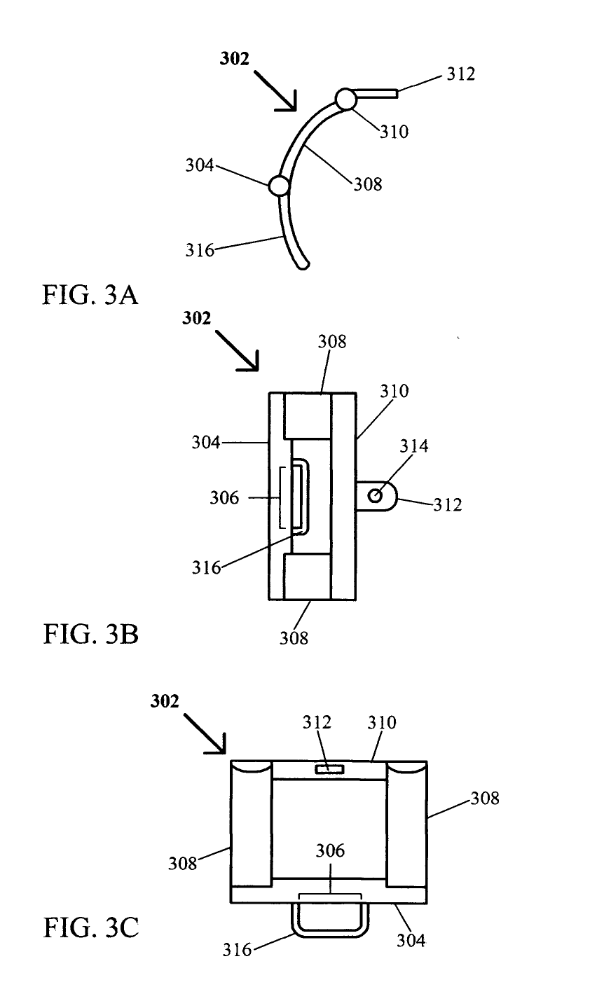

FIG. 3A is a side view of the brake assembly 302 for the hand skate 100.

FIG. 3B is a top view of the brake assembly 302 with the front to the right. A crossbar 304 extends perpendicular to the direction of travel, extending the full width of the hand skate 100. The middle section, area 306, of the crossbar 304 fits into channel 228 on the rear of the frame 202 (not shown). At the both ends of the crossbar 304, a plate 308 extends upward toward the front of the brake assembly 302. A top crossbar 310 connects to the top of the plates 308. A mounting tab 312 is attached to the middle of the top crossbar 310, pointing forward. A hole 314 for the brake cable mounting bolt 514 (not shown) is in the middle of the mounting tab 312. A U-shaped loop 316 is attached to the bottom of the crossbar 304.

FIG. 3C is a front view of the brake assembly 302. As shown in FIG. 3C the U-shaped loop 316 attaches to the crossbar 304 on both sides of the section 306.

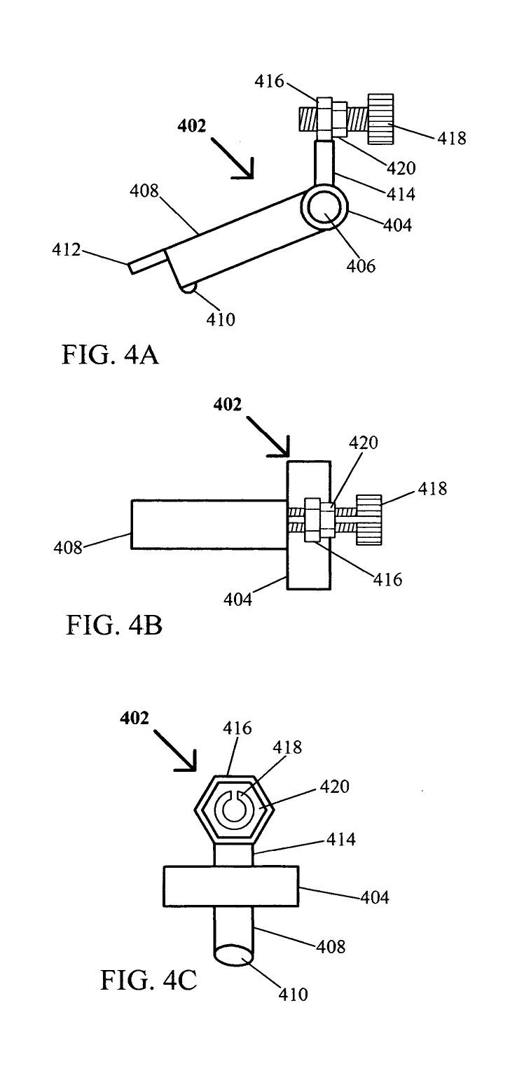

FIG. 4A is a side view of the brake lever assembly 402 used on the hand skate 100. A tube 404 is placed perpendicular to the direction of travel. The brake lever pivot bolt 518 (not shown) passes through the hole 406 in the tube 404. A brake lever arm 408 extends back and down from the middle of the tube 404. A finger grip ridge 410 is located at the bottom back of the brake lever arm 408. A brake lever stop 412 extends from the back top of the brake lever arm 408. A short spacer 414 extends up from the top middle of the tube 404. A threaded mount 416 is placed on top of the spacer 414 with the hole to the front. A standard bicycle brake lever adjustment bolt 418 is installed in the adjustment mount 416. An adjustment lock nut 420 is placed on the adjustment bolt 418.

FIG. 4B is a top view of the brake lever assembly 402 with the front to the right.

FIG. 4C is a front view of the brake lever assembly 402.

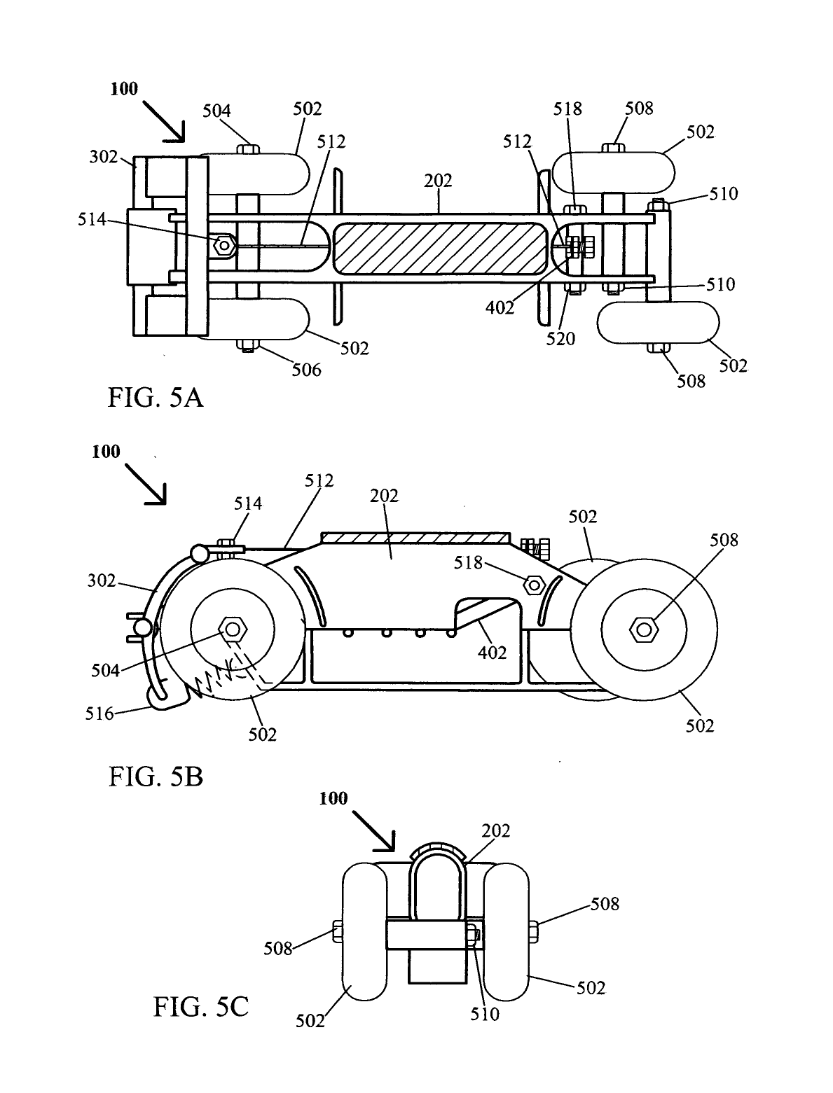

FIG. 5A is a top view of the hand skate 100 with the front to the right. The wheels 502 are standard in-line recreation wheels, complete with bearings. The rear axle bolt 504 passes through one wheel 502, then the rear axle tube 216 of the frame 202, then a second wheel 502 and is secured with a locking nut 506. The first front axle bolt 508 passes through a wheel 502, then through the front axle tube 218 on the side that extends past the frame 202 and is secured with a lock nut 510. The second front axle bolt 508 passes through a wheel 502, then through the second front axle tube 219 on the side that extends past the frame 202 and is secured with a lock nut 510.

FIG. 5B is a side view of the hand skate 100. The brake lever assembly 402 is placed inside the frame assembly 202. The brake lever pivot bolt 518 passes through the hole 226 on the first side of the frame 202, then through the hole 406 in the brake lever assembly 402, then through the second hole 226 on the second side of the frame 202 and is secured with a lock nut 520. The pivot section 306 of the brake assembly 302 is placed in the U-shaped channel 228 of the frame 202. The U-shaped loop 316 fits on both sides of the U-shaped channel 228 preventing side-to-side movement of the brake assembly 302. The two plates 308 on the brake assembly 302 are behind the two rear wheels 502. A brake spring 516 is attached to the brake spring mount 230 on the frame 202 and to the bottom of the U-shaped loop 316 on the brake assembly 302. A standard bicycle brake cable 512 passes through the cable adjustment bolt 418 of the brake lever 402, then through the frame 202 from front to back and then is bolted to the tab 312 on the brake assembly 302 with the brake cable mounting bolt 514. The brake lever 402 is exposed in the cutout 224 of the frame 202. The brake lever stop 412 keeps the brake lever arm 408 even with the bottom of the handle 203 of the frame 202. When the front finger of the skater pulls the brake lever arm 408 up, the brake lever 402 pivots on the brake lever pivot bolt 518, pulling the brake cable 512 forward. The brake cable 512 then pulls the plates 308 of the brake assembly 302 against the rear wheels 502, slowing or stopping the hand skate 100. When the brake cable 512 is not pulled, the brake spring 516 pulls the bottom of the brake assembly 302 forward, pivoting the top of the brake assembly 302 rearward away from the wheels 502. This also pulls the cable 512 rearward until the brake lever stop 412 on the brake lever assembly 402 contacts the frame 202.

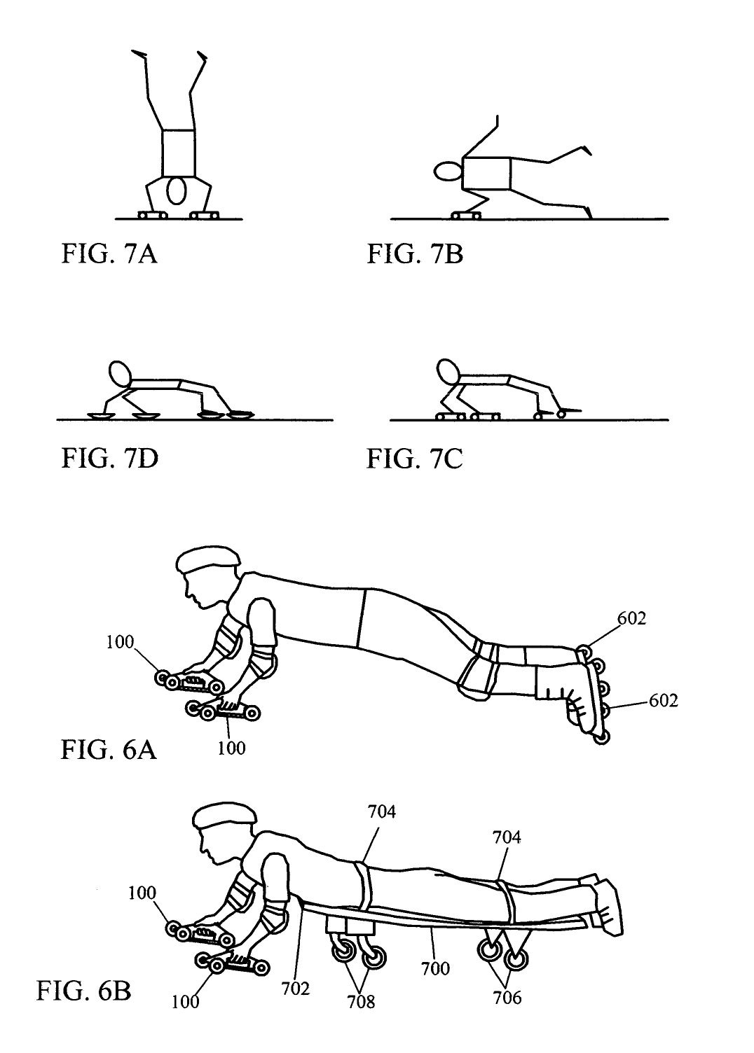

FIG. 6A shows a skater in the prone or push-up position, wearing in-line skates 602 and holding a hand skate 100 in each hand. In use, the skater can also be in a standing position, a hand stand position or a crab position. The skater can roll on sidewalks, skatepark ramps or any other hard surface. The skater can lift one hand skate 100, one inline skate 602 or one hand skate 100 and one in-line skate 602 at any time. There are numerous possible transitions between these main positions, rolling or standing still. The brakes on the hand skates 100 allow the skater to slow down or remain stationary. Steering is accomplished by lifting the hand skates 100 and setting them back on the hard surface in a new direction. Steering can also be accomplished while rolling by rotating the hands and hand skates 100 to the right or left while maintaining contact with the hard surface. The skater can propel himself with the hand skates or with skate devices worn on the feet or may coast using momentum or gravity.

FIG. 6B shows a skater in the prone position with a wheeled cart 700 supporting the lower body and holding a hand skate 100 in each hand. The wheeled cart 700 has a board or frame 702 to support the body of the skater. Straps 704 hold the skater on the cart 700. The cart 700 has two fixed wheels 706 placed near the rear of the cart 700. The fixed wheels 706 help the cart 700 maintain a direction once established. Two caster wheels 708, located near the front of the cart 700, support part of the load and allow the cart 700 to be steered by the skater using the hand held skates 100. The skater would propel himself, steer, and brake with the hand held skates 100. In use the skater could roll on sidewalks or other hard surfaces.

FIG. 7A shows a skater using two hand held skates in the hand stand position

FIG. 7B shows a skater using one hand held skate.

FIG. 7C shows a skater using two hand held skates in conjunction with heeling apparatus on the feet.

FIG. 7D shows a skater using two hand held ice skates in conjunction with ice skating devices on the feet.

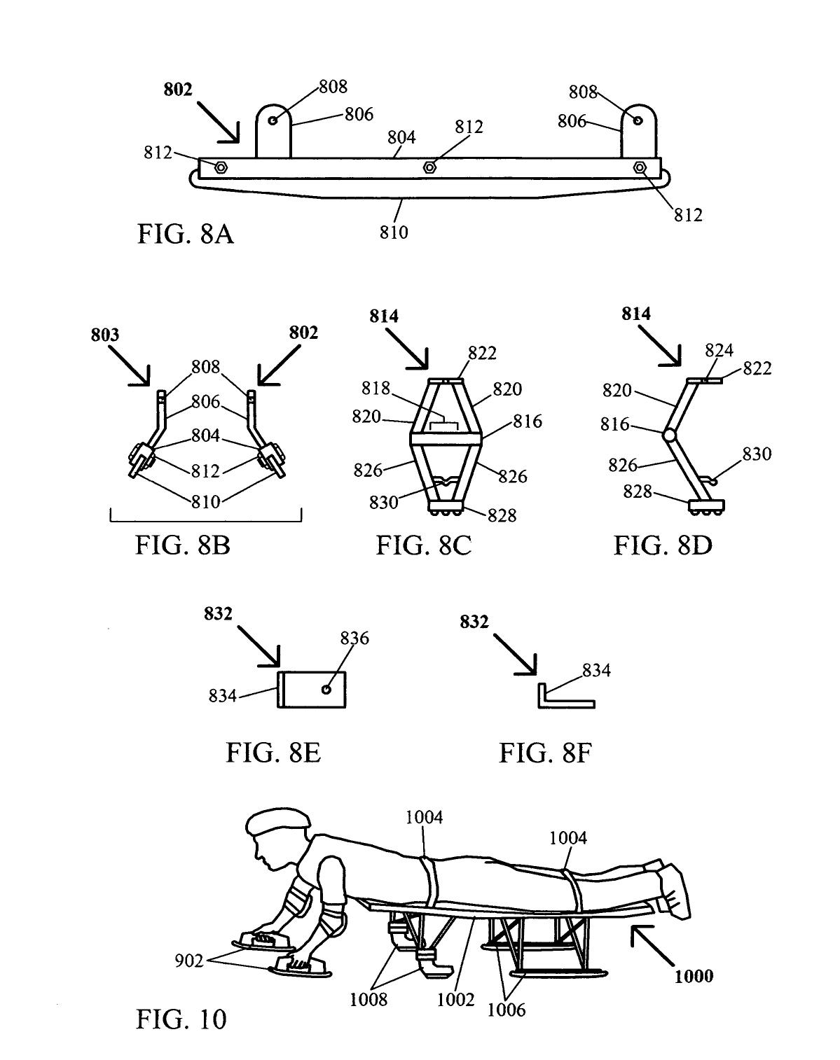

FIG. 8A is a side view of an ice runner assembly 802 that is attached to each side of the frame 202 (not shown). An ice blade 810 is held in a blade clamp 804 with fasteners 812. Two vertical braces 806 extend up from the blade clamp 804. The vertical braces 806 have holes 808 for the axle bolts 504 and 508.

FIG. 8B is a cross section of the blade assemblies 802 and 803. The left blade assembly 802 is canted to the left and the right blade assembly 803 is canted to the right.

FIG. 8C is a front view of the ice brake assembly 814. A crossbar 816 is perpendicular to direction of travel. A pivot section 818 in the center of crossbar 816 fits into the U-shaped channel 228 on the frame 202 (not shown). Upper arms 820 on both sides of the pivot section 818 extend upward to a mounting tab 822. Lower arms 826 on both sides of the pivot section 818 extend down to an ice gripping foot 828. A brake spring loop 830 attaches to the lower arms 826 just above the ice gripping foot 828.

FIG. 8D is a side view of the ice brake assembly 814 with the front to the right. A hole 824 (indicated by shading), for the brake cable mounting bolt 514, is in the top of the mounting tab 822.

FIG. 8E is a side view of the clamp 832 for the ice brake assembly 814. The clamp 832 has a hole 836 near the front.

FIG. 8F is a side view of the clamp 832 with the front to the right. The back of the clamp 832 has a bent up tab 834.

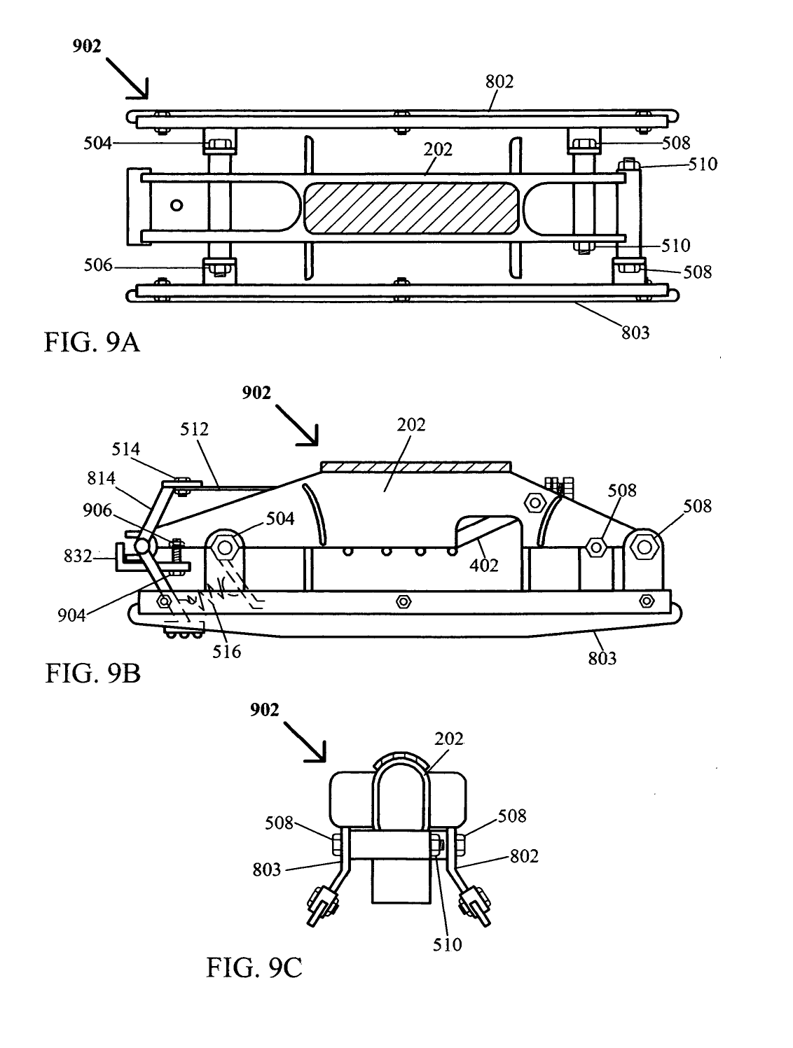

FIG. 9A is a top view of the hand skate 902 (hand skate 100 with ice skate accessories attached) with the front to the right. The rear axle bolt 504 passes through hole 808 of left ice runner assembly 802, then through tube 216 of the frame 202, then through the rear hole 808 of the right ice runner assembly 803 and is secured with a lock nut 506. The first front axle bolt 508 passes through the front hole 808 of the left ice runner assembly 802, then through the tube 218 of the frame 202 and is secured with a lock nut 510. the second front axle bolt 508 passes through the front hole 808 of the right ice runner assembly 803, then through the tube 219 of the frame 202 and is secured with a lock nut 510.

FIG. 9B is a side view of the hand skate 902. The pivot section 818 of the ice brake assembly 814 is in the U-shaped channel 228 of the frame 202. The bolt 904 passes through the hole 836 in the clamp 832, then through the hole 232 in the frame 202 and is secured with a lock nut 906. The bent up end 834 of the clamp 832 holds the ice brake assembly 814 in place. The brake cable 512 is attached to the tab 822 on the ice brake assembly 814 with bolt 514. The brake spring 516 attaches to the loop 230 on the frame 202 and to the loop 830 on the ice brake assembly 814. The braking action causes the ice gripping foot 828 to contact the ice surface.

FIG. 9C is a cross section of the hand skate 902. This view shows the ice runners 802 and 803 canted to the sides to facilitate the side thrust of hand skating.

FIG. 10A is a perspective of a skater in the prone position holding one hand held skate 902 in each hand. The skater's lower body is supported on an ice cart 1000. The ice cart 1000 has a board or framework 1002 to support the body of the skater. Straps 1004 hold the skater on the ice cart 1000. The ice cart 1000 has two fixed ice blades 1006 near the rear. The fixed ice runners 1006 cause the ice cart 1000 to glide straight behind the upper body of the skater. Two castered ice blades 1008 support part of the load and allow the ice cart 1000 to be steered by the hands. In use the skater could glide on ice and propel himself, steer and brake with the hand ice skates 902. Also a skater could ice skate in the pushup position while holding a hand held ice skate 902 in each hand and wearing a pair of ice skating boots with some type of ice blade vertically mounted on the toes (not shown).

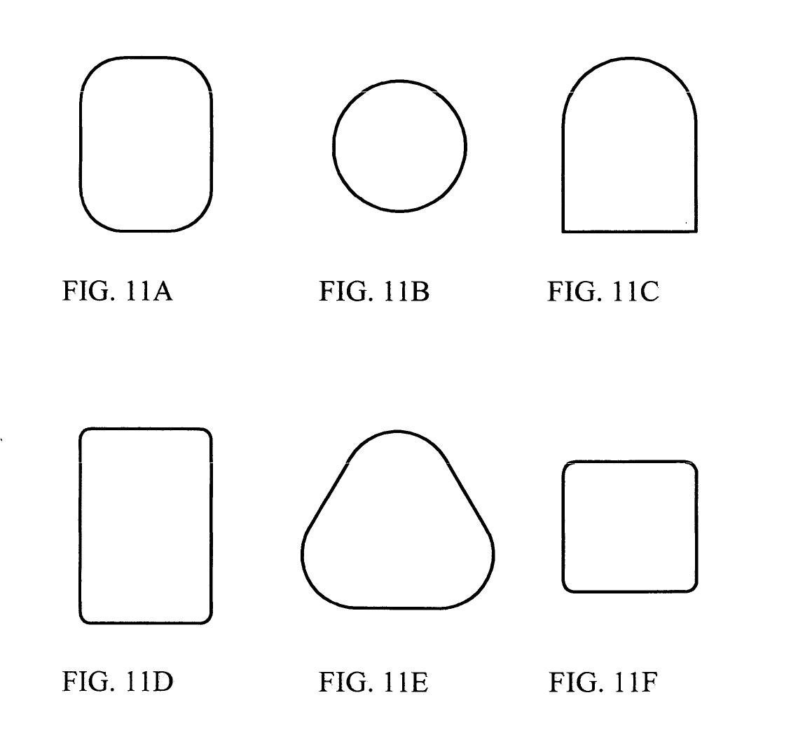

FIGS. 11-14 are possible frame parts including handles, hand guards, fenders and grind plates. Various hand held skates would have different combinations of these parts, and others not shown, depending on the sport or activity the invention was used for.

FIGS. 11A-11F are cross sections of some of the possible handle shapes.

FIG. 11A is the preferred embodiment, and is rectangular and rounded on all four corners.

FIG. 11B is round.

FIG. 11C is a rectangle that is only rounded on two corners.

FIG. 11D is a rectangle with the corners not rounded.

FIG. 11E is a triangle with rounded corners.

FIG. 11F is square. The size of the handle and corner radius can vary to enable individuals of varying hand sizes to use the invention. The orientation of the shapes is not limited to the drawings shown but can vary to facilitate multiple activities. Many different padding types and ergonomic shapes, such as are commonly used on hand tools and sports equipment can be used on the different hand skates. Although the handle on the preferred embodiment is parallel to the direction of travel, the handle can be mounted in the frame and tilted varying degrees to the left, right, up or down.

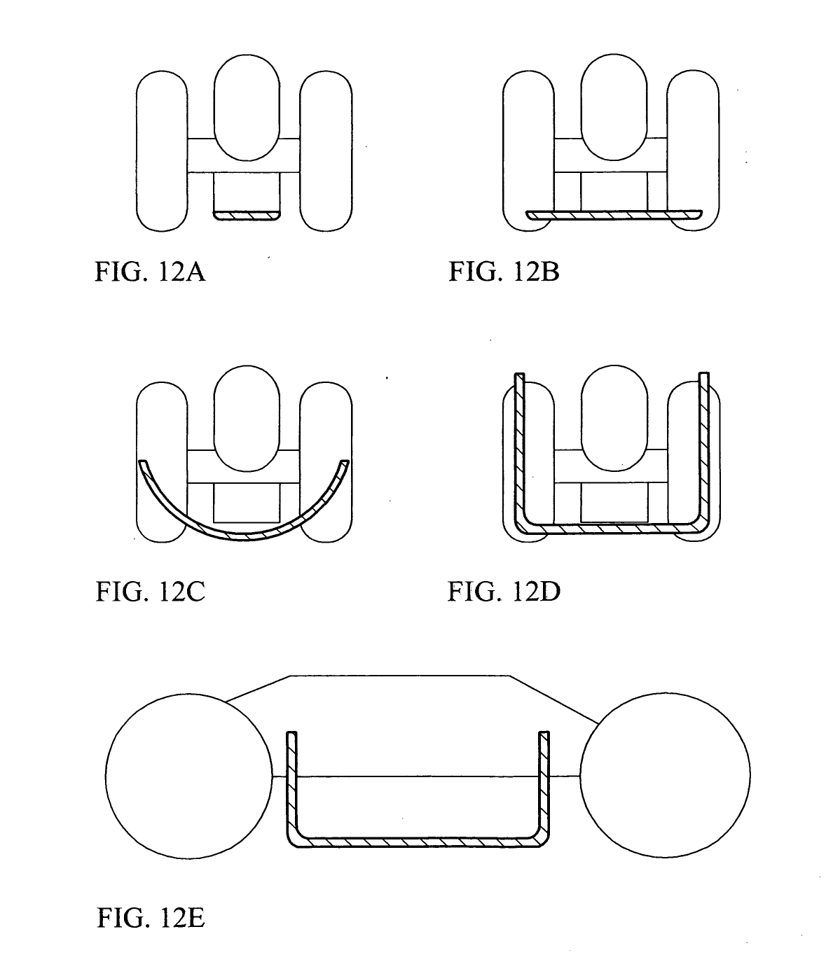

FIG. 12A is an end view showing the hand guard below the handle only.

FIG. 12B is an end view showing a flat hand guard below the handle, extending to the left and right sides of the hand skate.

FIG. 12C is an end view showing the hand guard extending from below the handle and up both sides to a point even with the axles.

FIG. 12D is an end view showing the hand guard extending from below the handle, up both sides to a point even with the top of the wheels.

FIG. 12E is a side view which show the hand guards do not extend beyond the front or back of the handle.

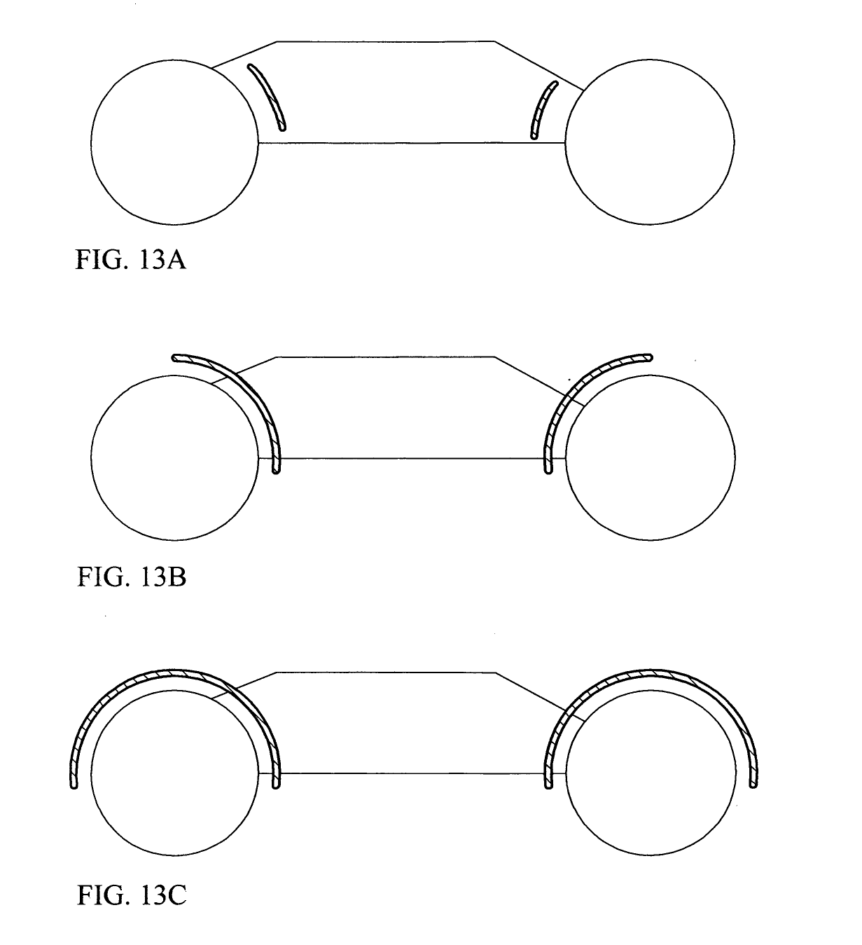

FIGS. 13A-13C are side views of the invention with some possible variations of fenders shaded.

FIG. 13A shows the fenders on the preferred embodiment extending to the side from the frame only.

FIG. 13B shows fenders extending from the frame to the tops of the wheels.

FIG. 13C shows fenders extending from the front of the wheels, over the top and to the back of the wheels.

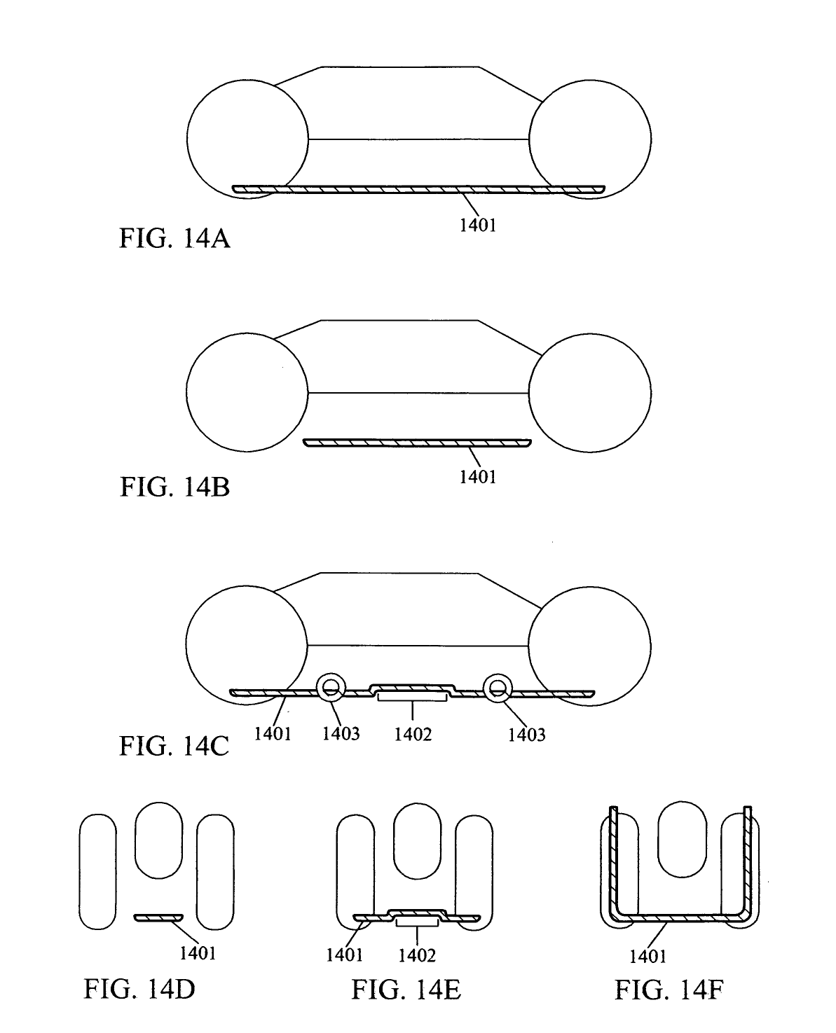

FIGS. 14A-14F are side and end views of the invention with possible variations of grind plates shaded.

FIG. 14A is a side view of the preferred embodiment showing the grind plate 1401 extending from the front axle to the back axle.

FIG. 14B show a side view with the grind plate 1401 below the handle only.

FIG. 14C is a side view showing the grind plate 1401 with an indention 1402 to guide the hand skate on a grind rail when grinding sideways. The figure also shows small wheels 1403 on the grind plate 1401 to aid in grinding.

FIG. 14D is an end view of the preferred embodiment showing the grind plate 1401 below the handle only.

FIG. 14E shows a grind plate 1401 extending from the left side to the right side of the hand skate. The figure also shows an indention 1402 to guide the hand skate on a grind rail when grinding front to back.

FIG. 14F is an end view showing a grind plate 1401 extending across the bottom and up both sides of the hand skate.

FIGS. 15A-G show some possible wheel shapes and some of their advantages.

FIG. 15A is a standard recreational in-line skate wheel used on the preferred embodiment.

FIG. 15B shows a wide contact surface with small rounded corners that is the wheel style used on most modern skate boards.

FIG. 15C is a flat surface wheel with square corners.

FIG. 15D, along with FIGS. 15E-15G, is an extra wide wheel that provides more stability and control when side thrust is applied. In particular,

FIG. 15D has small rounded corners.

FIG. 15E has square corners,

FIG. 15F has two rounded humps with an indention in the middle to roll over small object or roll on grind rails.

FIG. 15G has two humps with square corners and an indention in the middle.

Wheel size could vary from less than an inch in diameter to over six inches in diameter. The material and design of the wheel construction would vary, dependant on the surface the device would be used on.

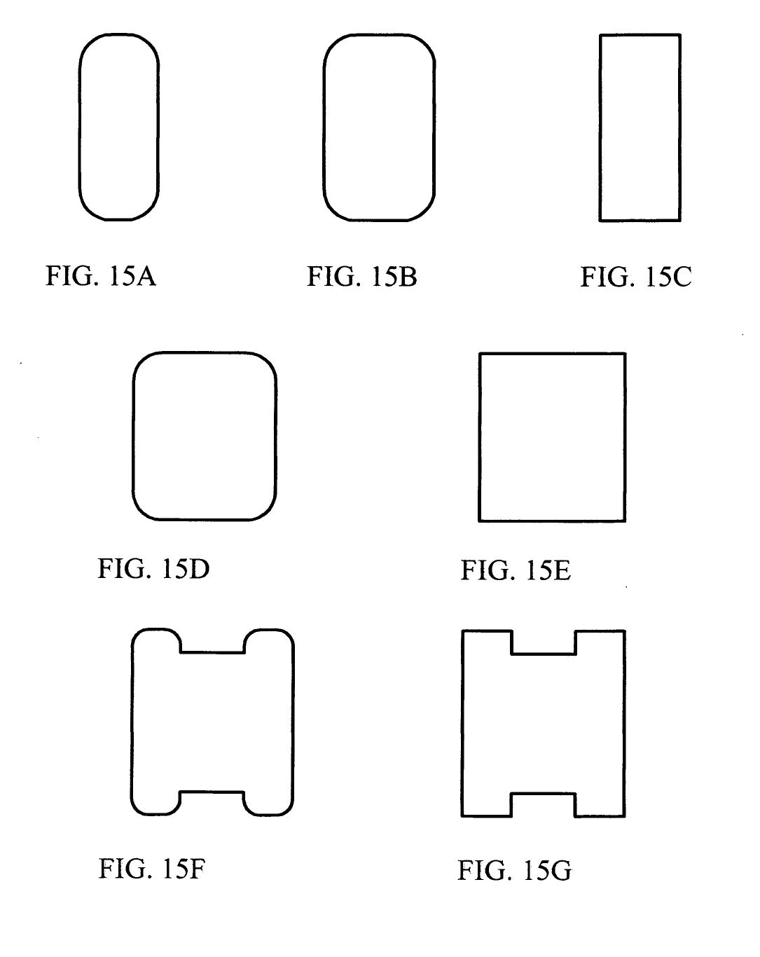

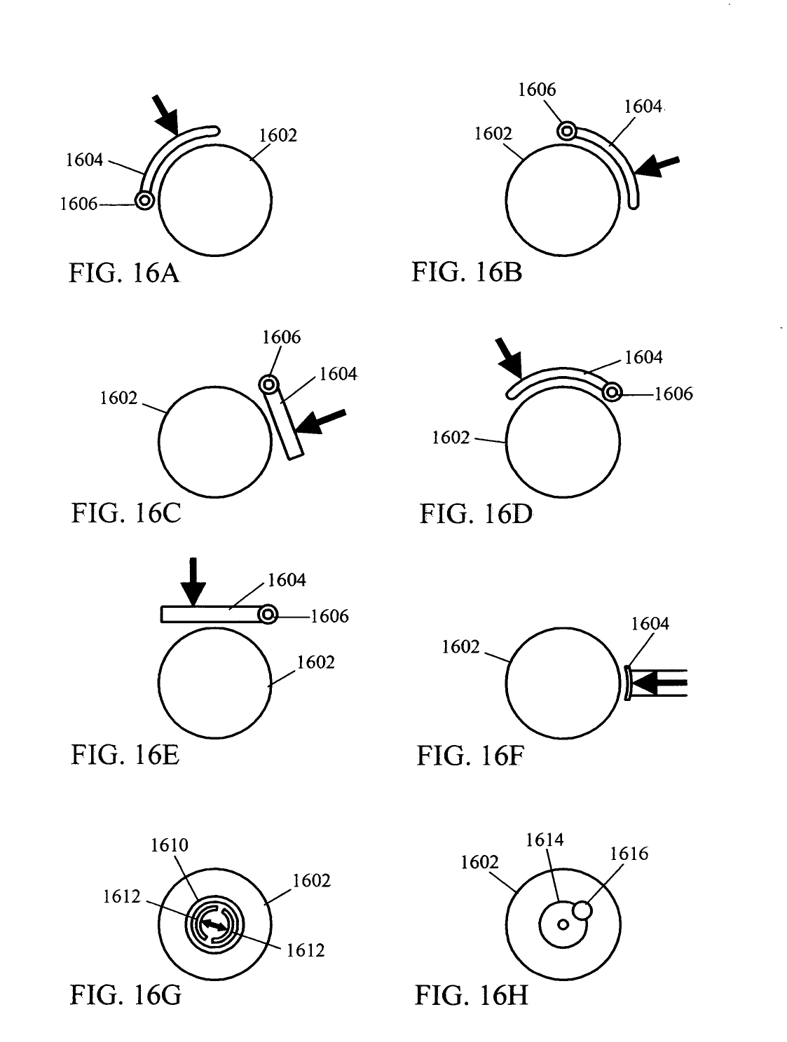

FIG. 16A is a side view of a possible brake system using a rub arm 1604 that has a pivot point 1606. When force is applied as indicated in FIG. 16A, the curved rub arm 1604 pushes against the outside of the wheel 1602. FIG. 16A, the preferred embodiment, shows the pivot point 1606 behind the wheel 1602.

FIG. 16B shows the pivot point 1606 at the top and the curved rub arm 1604 extends to the front of the wheel 1602.

FIG. 16C has the pivot point 1606 at the top front of the wheel 1602 and a straight rub arm 1604 pointing down.

FIG. 16D has the pivot point 1606 in front of the wheel 1602 and a curved rub arm 1604 extending back to the top of the wheel 1602.

FIG. 16E has the pivot point 1606 at the top front and a straight rub arm 1604 pointing straight back. In FIGS. 16A-16E, the rub arm 1604 should have suitable brake lining material and can also be formed as part of the fenders.

FIG. 16F shows the applied force pushing a brake pad 1604 straight against the wheel 1602.

FIG. 16G shows an automotive type brake drum attached to the wheel 1602. Brake shoes 1612 are pushed by the applied force against the brake drum 1610.

FIG. 16H is a view of an automotive style brake disc 1614 attached to the wheel 1602. A brake caliper 1616 presses against the disc 1614 when force is applied. Bicycle type brakes and various other type brakes may also be used.

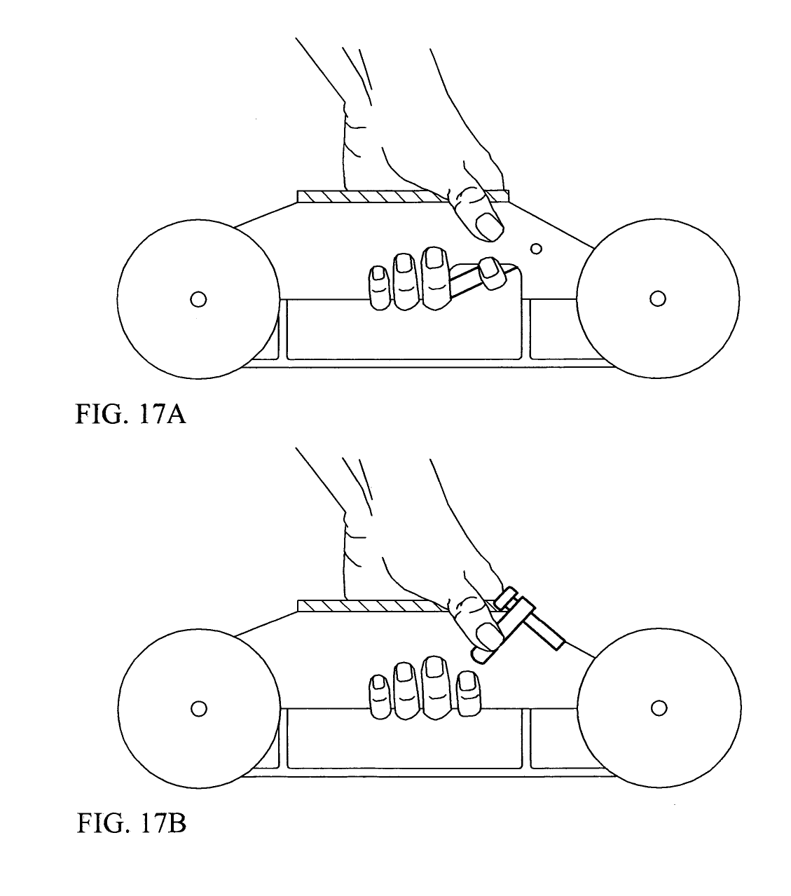

FIG. 17A is a perspective view of a finger operated brake lever such as is used on the preferred embodiment.

FIG. 17B is a perspective view of a thumb operated brake lever. Even though the preferred embodiment uses a cable between the brake lever and the brake system at the wheels, other linkage types may be used such as push linkage, pull linkage, hydraulic, electric or any suitable method. Brakes may be applied to one or more wheels, front and/or back. Anti-lock brake systems and a parking brake may be built into the brake system. For certain uses hand held skates may not need brakes.

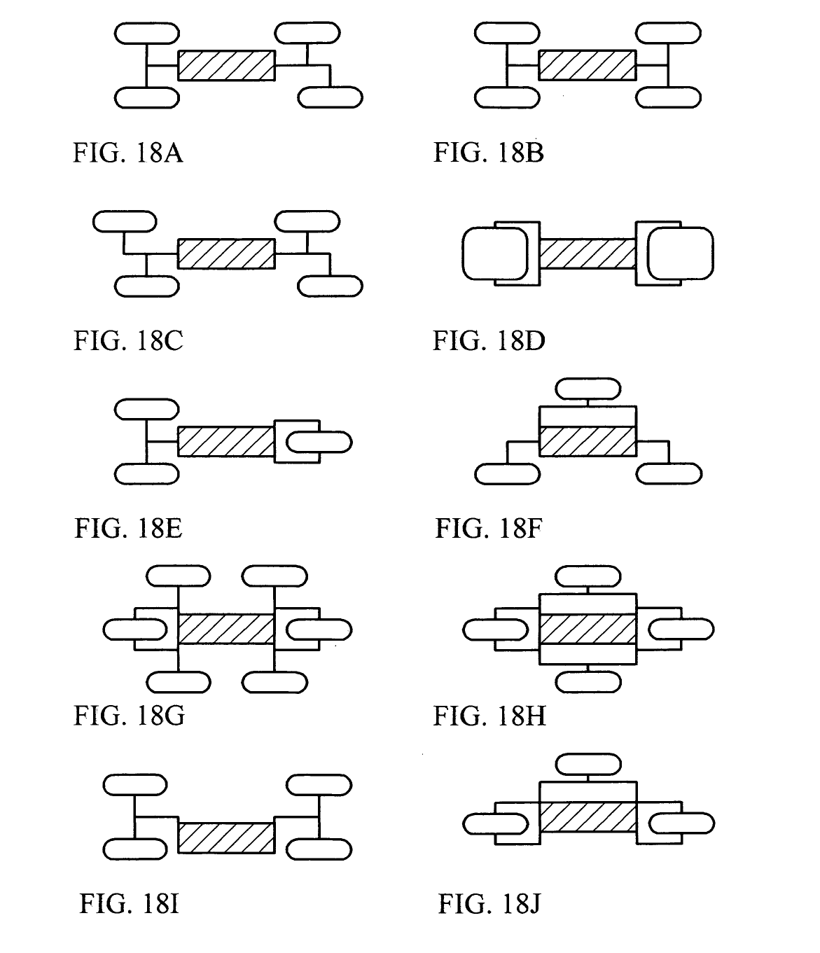

FIGS. 18A-18J are top views of some ways to arrange the wheels around the handle (shaded). FIG. 18A is the preferred embodiment. Having the two back wheels in line side to side keep the weight distribution equal when brakes are applied to the back wheels. Having the front wheels offset a certain amount allows them to cross over cracks, uneven surfaces and other obstacles more easily. A pair of hand skates could have identical wheel arrangements or have opposing offset front wheels. For example, the left front wheel could be offset to the front on the hand skate held in the left hand and the right front wheel offset to the front on the hand skate held in the right hand.

FIG. 18B shows front and back wheels in-line side to side, making the hand skate more compact.

FIG. 18C shows rear wheels and front wheels both offset.

FIG. 18D is a two wheeled hand skate which would require wide wheels for lateral stability.

FIG. 18E shows a three wheeled hand skate with two wheels behind and one in front of the handle. A three wheeled hand skate could also have two wheels in front and one wheel behind the handle.

FIG. 18F is a three wheeled hand skate with two wheels on the first side and one wheel on the second side of the handle.

FIG. 18G shows a six wheeled hand skate with one wheel in front, one wheel behind and two wheels on either side of the handle.

FIG. 18H shows a four wheeled hand skate with one wheel in front, one wheel behind and one wheel on either side of the handle.

FIGS. 18I-18J show four and three wheeled hand skates with the handle offset to one side. Having the handle offset would help stability when side force is applied. In FIGS. 18A-18J, different frame styles could be combined to create many possible wheel arrangements around the handle. Suspension and flex in the frame could be added to absorb shock.

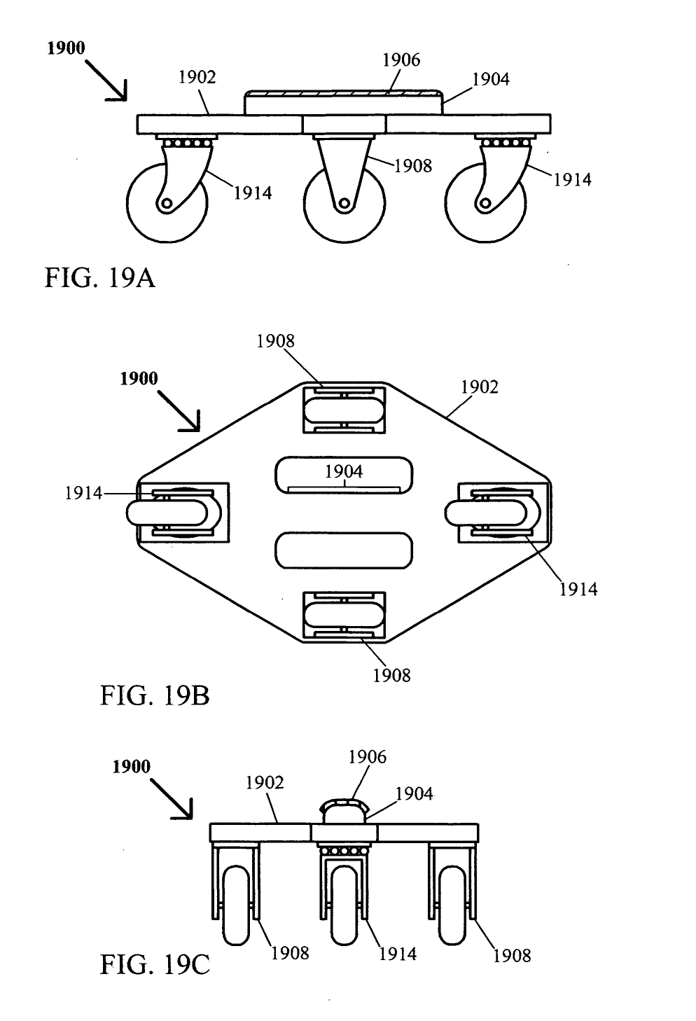

FIGS. 19A-19C are views of an alternate embodiment which has a zero turning radius (ZTR). This ZTR hand skate 1900 would be similar to a common stock cart with fixed wheels in the middle and casters on each end. FIG. 19A is a side view of a ZTR hand skate 1900 showing the frame 1902 extending from the front to the back. A handle 1904 with padding 1906 is in the middle of the frame 1902. A fixed wheel 1908 is attached to the bottom center of the frame 1902. Two castered wheels 1914 are attached to the frame 1902, one at the back and one at the front.

FIG. 19B is a bottom view of a ZTR hand skate 1900 showing the handle 1904 in the middle of the frame 1902. Two fixed wheels 1908 are on each side of the handle 1904 attached to the frame 1902.

FIG. 19C is an end view of the ZTR hand skate 1900. Various wheel configurations which allow sharp turns, brake systems, hand guards and other accessories add to the versatility of the device.

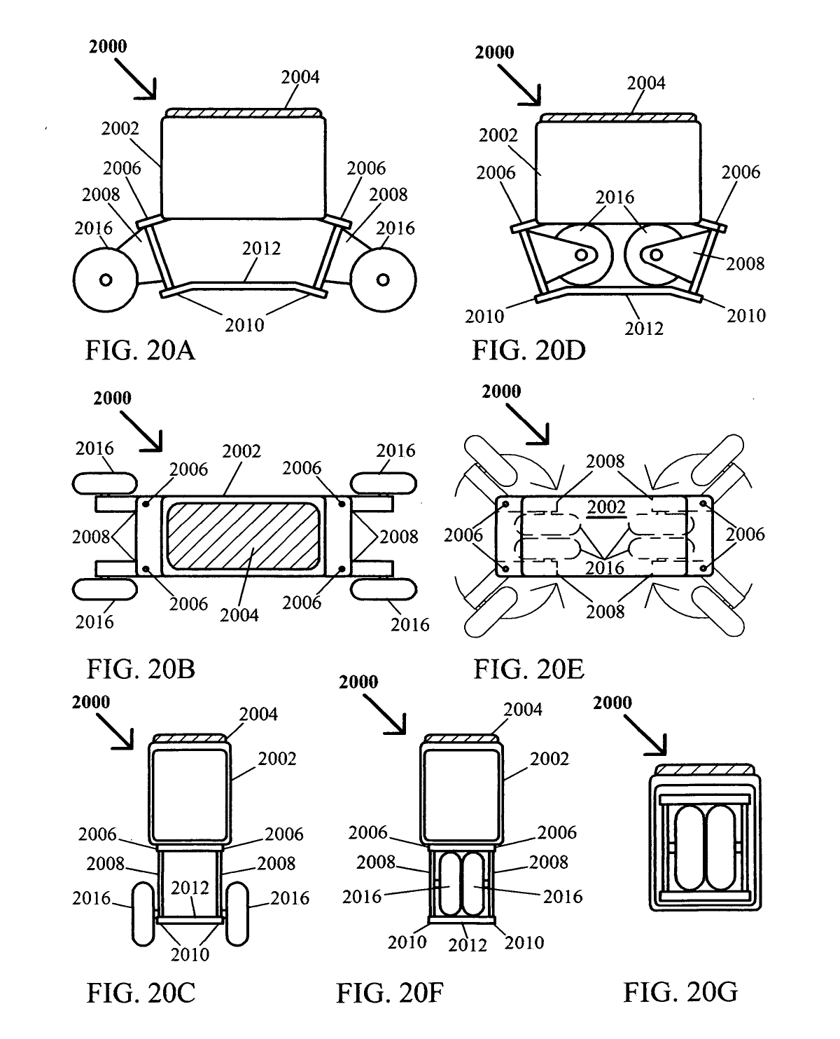

FIGS. 20A-20G show views of an alternate embodiment that consists of folding parts.

FIGS. 20A-20C show the folding hand skate 2000 with wheels 2016 extended.

FIG. 20A is a side view of the folding hand skate 2000 showing padding 2004 attached to the top of the tubular frame 2002. The wheels 2016 are attached to arms 2008 which are attached to the underside of the ends of the frame 2002 at pivot points 2006. The arms 2008 are attached to the ends of the lower frame 2012 at pivot points 2010.

FIG. 20B is a top view of the folding hand skate 2000 showing two wheels 2016 in front and two wheels 2016 behind the frame 2002.

FIG. 20C is an end view of the folding hand skate 2000.

FIGS. 20D-20G show the wheels 2016 folded into the folding hand skate 2000.

FIG. 20D is a side view of the folding hand skate 2000 showing the wheels 2016 nesting between the frame 2002 and the lower frame 2012.

FIG. 20E is a top view of the folding hand skate 2000 showing the arms 2008 as they swing on pivot points 2006 into the device.

FIG. 20F is an end view of the folding hand skate 2000.

FIG. 20G is an end view of a possible variation of the device which has wheels and lower frame nesting inside the upper frame. A locking mechanism (not shown) holds the arms in position. Brake systems and other accessories may be added. The folding hand skate and smaller versions of the non-folding hand skate can be easily carried in a large pocket.

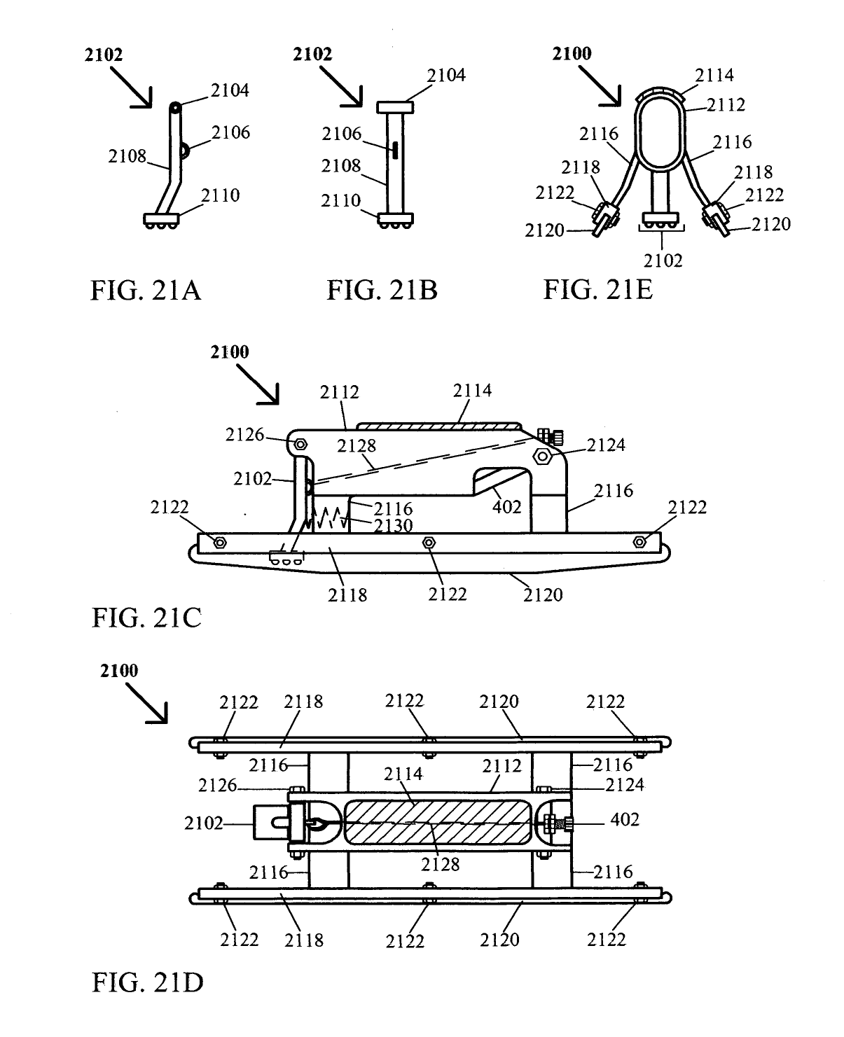

FIGS. 21A-21E are views of an ice hand held skate 2100 and its parts which are designed for use on ice only.

FIG. 21A is a side view of the ice brake arm 2102 with the front to the right showing a mounting tube 2104 attached to the top of a vertical brace 2108. A brake cable mounting loop 2106 is attached to the middle front of the vertical brace 2108, and an ice gripping foot 2110 is attached to the bottom of the vertical brace 2108.

FIG. 21B is a front view of the ice brake arm 2102.

FIG. 21C is a side view of the complete ice hand skate 2100 padding 2114 is attached to the top of the frame 2112. Braces 2116 extend down from the front and back of the frame 2112 and attach to the top of the ice blade clamps 2118. Ice blades 2120 are attached to the ice blade clamps 2118 with bolts 2122. The brake lever assembly 402 is mounted in the frame 2112 with pivot bolt 2124, in the same manner as on the preferred embodiment. The ice brake 2102 mounts at the top rear of the frame 2112 with pivot bolt 2126. A brake cable 2128 connected to the brake lever 402 attaches to the loop 2106 on the ice brake 2102. A spring 2130 pushes the ice brake 2102 back and away from the ice when the brake cable 2128 is not pulled.

FIG. 21D is a top view of the ice hand skate 2100. Two or more ice blades 2120 could be used as long as part of an ice blade 2120 extended in front, behind and to both sides of the handle to provide side to side and front to back stability.

FIG. 21E is an end view of the ice hand skate 2100 canted to withstand the side thrust.

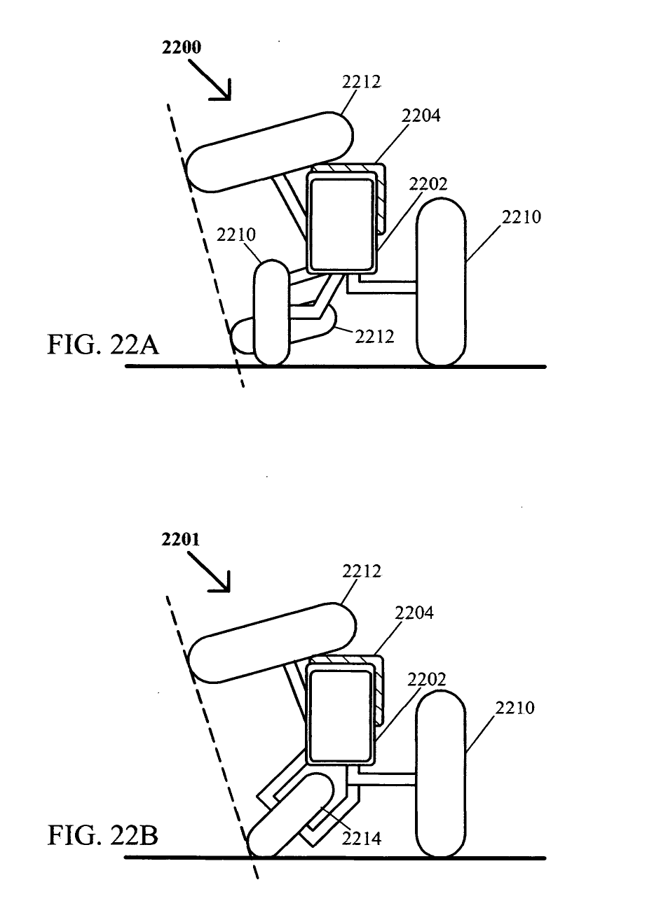

FIGS. 22A-22B are end views of alternate embodiments which have vertically oriented wheels as well as wheels oriented to one side.

FIG. 22A is an eight wheeled hand skate 2200 that has a frame 2202 with padding 2204 on the top. Typically the device will roll on a somewhat horizontal surface. Wheels 2210 attached to frame 2202 contact the horizontal surface in a normal manner. The dash line represents the surface the hand skate 2200 is capable of rolling on with the first side against the more vertical surface. Wheels 2212 extend out from the first side of frame 2202 and contact the more vertical surface in the side down mode. The hand skate 2200 has two wheels 2210 and two wheels 2212 both in front and behind the handle.

FIG. 22B is a six wheeled hand skate 2201 with wheels 2210 attached to the frame 2202 which typically contact the horizontal surface. Wheels 2212 extend out from the first side of the frame 2202 and contact the vertical surface in the side down mode. Wheels 2214 extend from frame 2202 and contact the surface in the normal and side down modes. The hand skate 2200 has one wheel 2210, one wheel 2212 and one wheel 2214 both in front and behind the handle.

Through the construction, testing and study of many prototypes, it has become apparent there are hundreds of possible embodiments. The present invention may be used in sports such as racing, skateparks, roller rinks, sidewalks, break dancing, Olympics, X-Games, performing arts, gymnastics and many other ways. The vast number of possible wheels, frames, materials and accessories mean that each sport will have several embodiments. It has also become apparent that all of the variations have the same basic design.

What is claimed is:

1. A hand held skating device, comprising:
a) a skating device comprising a front, back, sides, and handle,
b) a plurality of surface contacting conveyance components, hereafter referred to as conveyance components, that allow said skating device to move along a surface,
c) wherein the improvement comprises said conveyance components extend to the front, back, and sides of said handle, whereby said conveyance components hold said skating device upright, thus enabling a user to have a relaxed grip on said handle when said skating device is in contact with said surface,
d) and wherein a second improvement comprises at least one of said conveyance components is fixed directionally, thus enabling the user to maintain directional control.

2. The skating device of claim 1 wherein said conveyance components are directionally fixed thus only allowing said skating device to move in a forward or backward direction.

3. The skating device of claim 2 wherein said conveyance components are comprised of at least 3 wheels.

4. The skating device of claim 3 further including a brake system with a brake actuator, thus allowing user to slow down, come to a complete stop, or hold a position.

5. The skating device of claim 4 further including a grind plate.

6. The skating device of claim 5 wherein said skating device allows the removal of said wheels and an optional ice blade conveyance components to be installed, thus allowing said skating device to be used on ice.

7. The skating device of claim 4 further including a foldable frame system, thus enabling the skating device to be compactly stored.

8. The skating device of claim 2, wherein said conveyance components are comprised of at least two wheels wherein said wheels have a width which extends beyond both sides of said handle, thus allowing said wheels to hold said skating device upright.

9. The skating device of claim 8 further including a brake system with a brake actuator.

10. The skating device of claim 9 further including a grind plate.

11. The skating device of claim 2, wherein said conveyance components are comprised of ice blade assemblies.

12. The skating device of claim 11, further including a brake system with a brake actuator, thus allowing the user to slow down without raising ice blades off ice surface.

13. The skating device of claim 1, wherein said conveyance components are comprised of at least three wheels,
a) wherein at least one of said wheels is directionally fixed,
b) and the remainder of said wheels being castered wheels,
whereby said user can maintain directional control and turn without lifting said skating device off said surface.

14. The skating device of claim 13, further including a brake system with a brake actuator, thus allowing the user to slow down.

15. A hand held skating device usable by a skater in the prone position comprising:
a) sports equipment comprising a plurality of supporting systems which allow said sports equipment to move across a surface,
b) a front, back, two sides, and a handle,
c) wherein the improvement comprises said supporting systems extending to the front, back, and both sides of said handle, thus enabling the supporting systems to hold said sports equipment upright,
d) wherein a second improvement comprises at least one of said supporting systems is fixed directionally thus enabling the user to maintain directional control.

16. The sports equipment of claim 15, wherein said supporting systems are comprised of at least three directionally fixed wheels, thus allowing said sports equipment to roll in a forward and backward direction only.

17. The sports equipment of claim 16, further including a brake system and a brake actuator, thus allowing the user to slow down, come to a complete stop, or hold a position.

18. The sports equipment of claim 15, wherein said supporting systems are comprised of at least two directionally fixed wheels wherein said wheels have a width which extends beyond both sides of said handle, thus allowing said wheels to hold said sports equipment upright.

19. The sports equipment of claim 15, wherein said supporting systems are comprised of ice blade assemblies.

20. The sports equipment of claim 15, wherein said supporting systems are comprised of at least three wheels,
a) wherein at least one of said wheels is directionally fixed,
b) and the remainder of the said wheels being castered wheels,
whereby said user can maintain directional control and turn without lifting said sports equipment off said surface.

21. A method of skating, comprising:
a) Providing a hand held skating device comprising,
i. a skating device comprising a front, back, sides, and handle,
ii. a plurality of surface contacting conveyance components, hereafter referred to as conveyance components, that allow said skating device to move along a surface,
iii. wherein the improvement comprises, said conveyance components extend to the front, back, and sides of said handle, whereby said conveyance components hold said skating device upright, thus enabling a user to have a relaxed grip on said handle when said skating device is in contact with said surface,
iv. and wherein a second improvement comprises, at least one of said conveyance components is fixed directionally, thus enabling the user to maintain directional control,
b) providing a skater holding said skating device in one hand,
c) having said skater lower said skating device to a surface,
whereby said skater can move on said surface with said skating device supporting said skater's upper body.

22. The method of claim 21, wherein said skater is holding two said skating devices.

23. The method of claim 22 wherein said skater is wearing skating footwear wherein said skating footwear supports and conveys said skater's lower body across a surface while said skating devices support and convey said skater's upper body across a surface.
